(19) United States
(12) Patent Application Publication
(10) Pub. No.: US 2007/0087220 A1
(43) Pub. Date: Apr. 19, 2007

(54) Stability enhancement of opto-electronic devices

(75) Inventors: Santos F. Alvarado, Rueschlikon (CH); Tilman A. Beierlein, Kilchberg (CH); Brian Crone, Santa Fe, NM (US); Siegfried F. Karg, Adliswil (CH); Peter Mueller, Zurich (CH); Heike E. Riel, Rueschlikon (CH); Walter Heinrich Riess, Thalwil (CH); Beat Ruhstaller, Feusisberg (CH)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/510,039

(22) Filed: Aug. 25, 2006

(30) Foreign Application Priority Data
Aug. 25, 2005 (EP) 05405494.5

(51) Int. Cl. B32B 19/00; B32B 9/00

(52) U.S. Cl. 428/690

(57) ABSTRACT

An electroluminescent device is provided that in sequence comprises an anode, a hole injecting layer, an emission layer comprising an emitting material, an electron injecting layer, and a cathode. The emission layer further comprises a stabilizing material whose energy bandgap is larger than the energy bandgap of the emitting material.

### TECHNICAL FIELD

The present invention is related to an electroluminescent device. More specifically, this invention relates to devices comprising an organic emission layer.

### BACKGROUND OF THE INVENTION

The basic mechanism of light emission of an electroluminescent device, such as an Organic Light-Emitting Diode (OLED), is the radiative recombination of an excited energy state into an energetically lower state. The excited energy state is originally formed by the combination of a positive and a negative charge carrier and potentially an energy transfer can occur from the originally excited energy state to another excited energy state, e.g., through exciton diffusion, Foerster transfer, Dexter transfer or the like. The combination of positive and negative charge carriers forms two types of excitations, namely, short-lived singlets (S) and long-lived triplets (T). Besides the desired radiative recombination of these excitations there exist competing non-radiative processes.

There exists a variety of transition processes an excited energy state can undergo, as described by Kao and Hwang, Electrical Transport in Solids, Pergamon Press, p. 470ff. In particular, the fusion of two excited energy states, e.g., S₁+S₁, T₁+T₁, S₁+T₁, leads to higher excited energy states, e.g., S₁*, T₁*, T₂, T₂*, etc. Molecules in such excited energy states are increasingly unstable and tend to decompose or initialize chemical reactions. With increasing density of excited energy states those fusion events become more and more probable. Therefore, the fusion of excited energy states can be a mechanism of significant degradation.

In U.S. Pat. No. 4,769,292 is described an electroluminescent device having a luminescent zone of less than one μm in thickness made of an organic host material capable of sustaining hole-electron recombination and a fluorescent material capable of emitting light in response to energy released by hole-electron recombination. A drawback of this bulk-emitting device is the low efficiency because only the emission of singlet excitons is used. Long-lived triplet excitons that are three times more often formed than singlet excitons are not utilized or deactivated. This may hence lead to a degradation of the device.

In known OLED systems conventional doping of organic layers is performed to improve the efficiency and color purity of organic light emitting devices. In these doped OLED systems the energy levels of the dopants lie within the energy bandgap of the organic host material. This allows effective exciton energy transfer from the host material to the dopant. Originally, fluorescent dyes were used as dopants which mainly utilize singlet excitons (S₁). Since the triplet excitons are however not deactivated, an accelerated device degeneration can occur. More recently, luminescent or phosphorescent dyes are employed that utilize both singlet (S₁) and triplet (T₁) excitons. Though having a higher starting efficiency, the efficiency decrease over time of such triplet-exploiting devices is still substantial. Additionally, devices with these dyes suffer from a decreasing efficiency with increasing operation current due to triplet-triplet annihilation.

It is an object of the present invention to provide an organic electroluminescent device with a reduced degradation rate and an increased efficiency.

### SUMMARY OF THE INVENTION

According to a first aspect of the invention the lifetime of organic and inorganic electronic and opto-electronic devices, e.g., OLEDs is increased. The lifetime and stability of organic and inorganic devices can be improved by addition of a material with an energy bandgap that is larger than the energy bandgap of a host material of an emitting layer, also referred to as active zone. Additionally, an increased efficiency of devices in particular of devices using phosphorescent dyes occurs.

The addition of a material, referred to as stabilizer, with an energy bandgap that is larger than the energy bandgap of the host material leads to an improvement in lifetime and stability without or with only minor negative effect on the emission and transport characteristics of the emitting layer. Stabilization arises from the fact, that the stabilizer deactivates high-energy excitations which are generated by excited energy state interactions in the active host material during operation. Therefore, degradation mechanisms such as photochemistry by excitations are reduced, resulting in a higher long-term stability of, for example, organic materials as host material. In addition, the additive stabilizer recycles a part of the energy of the deactivated excitations transferring the excitation energy back to the host material that can be a dye molecule. Hence, an increased efficiency is achieved.

The concept is not restricted to small-molecule host materials. It is more generally applicable, e.g. to polymers, organic/inorganic hybrid structures as well as host materials comprising polymers with a small-molecule additive.

In accordance with the present invention, there is provided an electroluminescent device that in sequence comprises an anode, a hole injecting and transporting layer, an emission layer comprising an emitting material, an electron transporting and injecting layer, and a cathode. The emission layer further comprises a stabilizing material capable of accepting energy of excited energy states of the emitting material. The stabilizing material has an energy bandgap that is larger than the energy bandgap of the emitting material. It also preferably has a reduction potential, also referred to as electron affinity, that is equal or less negative than the reduction potential of the emitting material.

In other words, the emission layer is enhanced with a material having a larger energy bandgap. This is achieved by the stabilizing material as additive.

In electroluminescent devices light emission is generated in a luminescent zone comprising a host material sustaining electron- and hole injection and a luminescent guest material capable of emitting light in response to hole-electron recombination. The introduction of the stabilizing material as an additional guest material leads to a reduction of the degradation rate. This stabilizing material as additional guest material, also referred to as stabilizer, is here selected to have a larger energy bandgap than the energy bandgap of the emitting material or host material. This is in contrary to conventional OLEDs which use luminescent guest materials with an energy bandgap that is smaller than the energy bandgap of the emitting material or host material. The larger bandgap of the stabilizing material provides a favored site for the excitation states of the emitting material. The excited energy states which are potentially causing degradation are hence faster depopulated and can cause less chemical degradation reactions. The excited energy state which was transferred to the stabilizing material can be further transferred back to the emitting material which equals a recycling of part of the energy. Alternatively, the excited energy state of the stabilizing material can undergo itself a recombination process. In another case, the stabilizing material itself can degrade with a certain probability which would correspond to a consumption of the stabilizing capability with time.

In order to achieve even better results the stabilizer can be adapted to the optical and electrical properties of the guest/host material within the emitting layer, e.g. by matching the energy levels of the stabilizer to the energy levels of the most probably occurring excited states of the guest/host material.

The emitting material can comprise an organic host material which can be selected from a wide range of materials. Further, the emitting material can comprise a luminescent material that allows the generation of a light emission. The stabilizing material can comprise a material from the class including carbazole, stilbene, fluorene, phenanthrene, and oligo-phenyls, which allows a selection from various suitable materials. A basic selection criterion can be that the molecule forms a solid at room temperature and its singlet and triplet energy states are higher than those of the emitting material.

In a preferred embodiment the stabilizing material can comprise a carbazole biphenyl or any of its derivatives such as 4,4′-N,N′-dicarbazole-biphenyl (CBP).

Such stabilizing material shows the advantage that besides a sufficiently high singlet and triplet energy state the glass transition temperature is relatively high, thereby reducing the negative effect of reducing the overall glass transition temperature of the device by the addition of the stabilizer material. The stabilizing material can also comprise a p-terphenyl or p-quarterphenyl or any of its derivatives, with the advantage of a sufficiently high singlet and triplet energy state combined with a sufficient chemical stability. The same is true for triphenylene. When the stabilizing material is provided in a concentration of 1-10% within the emission layer, then the advantage occurs that the device in a preferred manner exhibits a compromise between its improvement on efficiency and material degradation on one hand and stability and reliability on the other hand. The same applies to the stabilizing material in a concentration of 10⁻³ to 20 mole percent based on the moles of the emitting material.

It is particularly advantageous when the stabilizing material is chosen such as to provide sites for accepting energy of excited energy states of the emitting material, because then more reliable devices can be provided.

### DESCRIPTION OF THE DRAWINGS

Preferred embodiments of the invention are described in detail below, by way of example only, with reference to the following schematic drawings.

FIG. 1 shows a schematic illustration of an organic electroluminescent device.

FIG. 2 shows a schematic illustration of typical energy levels and energy transfer.

FIG. 3 shows a schematic illustration of energy levels and energy transfer with a stabilizing effect.

The drawings are provided for illustrative purpose only and do not necessarily represent practical examples of the present invention to scale.

### DESCRIPTION OF THE INVENTION

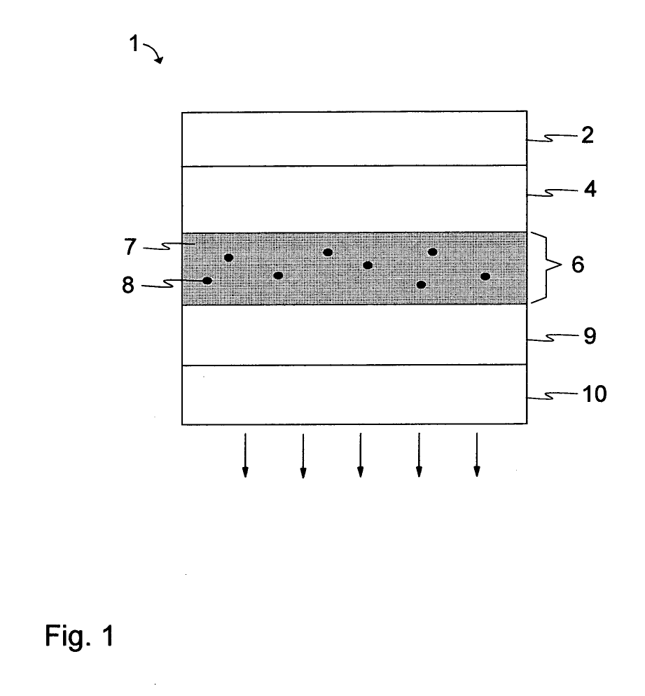

FIG. 1 shows a schematic illustration of an opto-electronic device that is illustrated as electroluminescent device 1. The device 1 comprises in sequence an anode 2, a hole injecting layer 4, an emission layer 6 comprising an emitting material 7, an electron injecting layer 9, and a cathode 10. The emitting material 7 can comprise a single organic material or can comprise a host material and a luminescent (guest or dopant) material. For example tri-(8-hydroxy-quinolinato)-aluminum (Alq) can be used as host material and rubrene as guest material. The emission layer 6 further comprises a stabilizing material 8, herein also referred to as stabilizer 8, that is capable of accepting energy of higher excited energy states of the emitting material 7. The stabilizing material 8 has an energy bandgap, referred to as second energy bandgap, that is larger than the energy bandgap of the emitting material 7, referred to as first energy bandgap, and a reduction potential equal or less negative than the emitting material 7. By applying a voltage to the anode 2 and the cathode 10, the emission layer 6 emits light through the electron injecting layer 9 and the cathode 10 to the outside, as indicated by the multiple arrows.

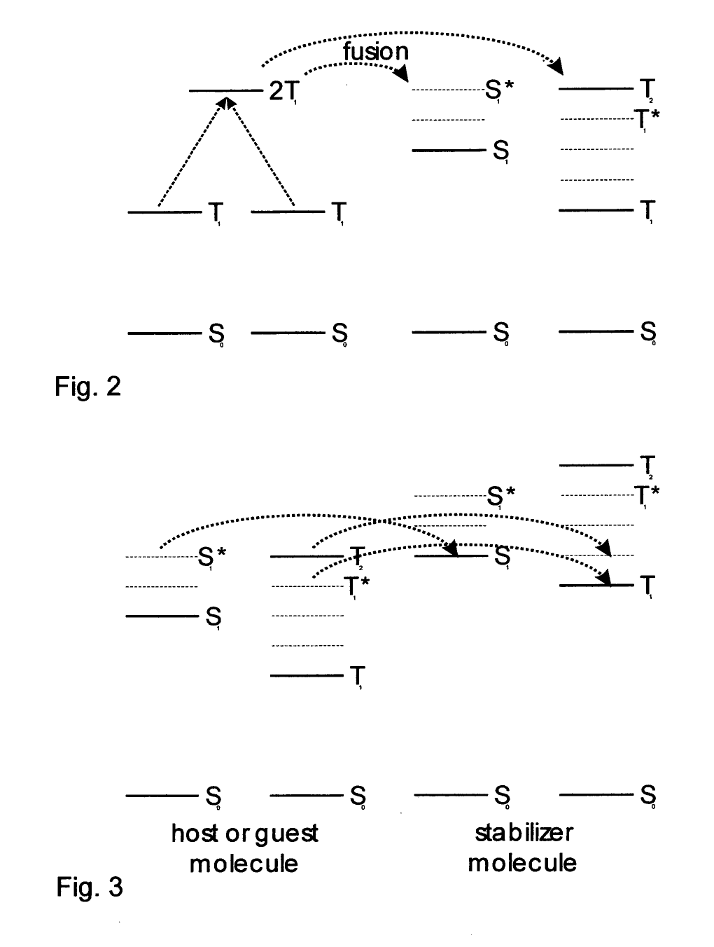

FIG. 2 shows typical energy levels and energy transfer for the example of a T₁+T₁ fusion process, also known as triplet-triplet annihilation, in an organic material. S₀ indicates a ground energy state. S₁ is a first excited singlet energy state. T₁ is a first excited triplet energy state. T₂ indicates a second excited triplet energy state. S₁* and T₁* are respectively vibronic levels of the S₁ and T₁ energy states. 2T₁ indicates a virtual energy state with the combined energy of two T₁ energy states.

As indicated in the figure with the arrows, the fusion of two molecules that are in the T₁ energy state can lead to one molecule in one of the energy states S₁*, T₁*, or T₂ while the other molecule is in the ground energy state S₀.

Organic molecules can have one of an excited singlet or an excited triplet energy state. In organic LEDs the presence of excited triplet energy states is undesired because the excited triplet energy states have the characteristic of being more stable than the excited singlet energy states while their relaxation does not contribute to light emission. Excited triplet energy states hence take away from the light emission efficiency of the OLED. Due to their longevity, the percentage of excited triplet energy states in the OLED material increases over time and hence continuously reduces the OLED efficiency. An alternative to an excited triplet energy state relaxing into a lower energy state can be the chemical alteration into a different material that does not emit light, which also exacerbates the OLED efficiency.

FIG. 2 illustrates that the triplet-triplet annihilation can either lead to the T₁* or T₂ energy state which are the above described undesired triplet energy states, or to the S₁* energy state which is a singlet energy state, and hence can relax while emitting light.

FIG. 3 illustrates energy levels and energy transfer with a stabilizing effect if the molecules within the emission layer 6 are in one of the S₁*, T₁*, T₂ energy states. The possible energy states for the molecules of the emitting material 7, also referred to as host or guest molecule or material, are shown on the left hand side of FIG. 3, whilst the energy states of the molecules of the stabilizing material 8, also referred to as stabilizer molecule, are shown on the right hand side of FIG. 3. The molecules of the stabilizing material 8 can accept energy from the various energy states of the molecules of the emitting material 7.

The host molecules that are in one of the energy states S₁*, T₁*, T₂ that can result from triplet-triplet annihilation, as indicated in FIG. 2 on its right hand side, now find the energy states S₁, T₁ of the stabilizing molecule to perform an energy transfer to. The vibronic energy state S₁* of the host molecule 7 can, as indicated e.g. transfer energy to the non-vibronic excited singlet energy state S₁ of the stabilizer 8, whereafter the non-vibronic excited singlet energy state S₁ of the stabilizer 8 can relax to the ground energy state S₀ while not generating light. The second excited triplet energy state T₂ of the host material 7 can transfer energy to the first excited triplet energy state T₁ of the stabilizer 8. The first excited triplet energy state T₁ is typically the excited energy state with an energy that is lower than the first excited singlet energy state S₁. If a molecule in the first excited singlet energy state S₁ is chemically stable, then usually the first excited triplet energy state T₁ is also stable.

The introduction of the stabilizer 8 as additional guest material leads to a reduction of the degradation rate. This stabilizer 8 is chosen to have an energy bandgap that is larger than the energy bandgap of the host material, i.e. of the emitting material 7. The larger energy bandgap of the additional guest material 8 provides to the emitting material 7 its first excited singlet energy state S₁ or its first excited triplet energy state T₁ as a favored site for receiving energy from the excited energy states: S₁*, T₁*, T₂, T₂*, etc., of the emitting material 7. The excited energy states resulting from the triplet-triplet annihilation of the emitting material 7 which are potentially causing degradation are hence faster depopulated and can thus cause less chemical degradation reactions. The excited energy state S₁ or T₁ which was created by the energy transfer at the stabilizer 8 can be further converted by transferring energy back to the emitting material 7, e.g. to its first excited singlet energy state S₁, which transfer equals a recycling of part of the energy. Alternatively, the newly created excited energy state of the stabilizer 8 can undergo itself a recombination process. In another case, the stabilizer 8 itself can undergo degradation with a certain probability which would equal a consumption of the stabilizing capability with time.

To choose for the stabilizer 8 a material capable of providing one or more favored sites for higher excited energy states involves relating the properties of the stabilizing material to the emitting material 7. Relevant relationships are the energy bandgap and the reduction potential.
1. The second energy bandgap of the stabilizer 8 should be equal or larger than the first energy bandgap of emitting material 7. This means that the distance between the first excited singlet energy state S₁ and the ground energy state S₀ of the stabilizer 8 is larger than the distance between the first excited singlet energy state S₁ of the host material 7 and its ground energy state S₀.

Thereby the energy transfer from the first excited singlet energy state S₁ of the host material 7 is aggravated, such that the stabilizer 8 does not take away from the desired efficiency of luminescent relaxation. Preferably also the distance between the first excited triplet energy state T₁ and the ground energy state S₀ of the stabilizer 8 is larger than the distance between the first excited singlet energy state S₁ of the host material 7 and its ground energy state S₀.
2. Also, at least one of the excited singlet energy state S₁ or first excited triplet energy state T₁ of the stabilizer 8 should not be higher than the virtual energy state consisting of the combined energy of two excited triplet energy states T₁, i.e. S₁(stabilizer) or T₁(stabilizer) is equal or smaller than 2T₁(host material). This facilitates the energy transfer from any of the resulting energy states S₁*, T₁*, T₂, T₂* of the triplet-triplet annihilation of the emitting material 7 to one of the energy states of the stabilizer 8.
3. The reduction potential of the stabilizer 8 should preferably be equal or smaller than the reduction potential of the emitting material 7. In other words the first excited singlet energy state S₁ and also the first excited triplet energy state T₁ of the stabilizer 8 are higher than the first excited singlet energy state S₁ of the host material 7. This contributes to the fact that then the energy transfer from the first excited singlet energy state S₁ of the host material 7 is aggravated, such that the stabilizer 8 does not take away from the desired efficiency of luminescent relaxation.

Preferably, the stabilizer 8 should have an absorption band that is wide enough to accept a variety of higher excited energy states of the emitting material 7. Preferred stabilizing materials are carbazoles (CBP), oligo-phenylenes (quarterphenyl) or p-quarterphenyl of the formula (p-4P), stilbenes, or materials from the class of carbazole, stilbene, and oligo-phenyls.

1. An electroluminescent device comprising an anode, a hole injecting layer formed on said anode, an emission layer formed on said hole injecting layer and comprising an emitting material with a first energy bandgap, an electron injecting layer formed on said emission layer, and a cathode formed on said electron injecting layer, wherein the emission layer further comprises a stabilizing material having a second energy bandgap that is larger than a first energy bandgap of said emitting material.

2. The device according to claim 1, wherein the emitting material comprises an organic material.

3. The device according to claim 2 wherein said organic emitting material comprises a luminescent material.

4. The device according to claim 1 wherein the stabilizing material comprises material selected from the class including carbazole, stilbene, and oligo-phenyls.

5. The device according to claim 4 wherein the stabilizing material comprises a carbazole biphenyl of the formula (CBP).

6. The device according to claim 4 wherein the stabilizing material comprises a p-quarterphenyl of the formula (p-4P).

7. The device according to claim 1, wherein the stabilizing material is present in a concentration of 1-20% within the emission layer.

8. The device according to claim 1, wherein the stabilizing material is present in a concentration of 10⁻³ to 20 mole percent based on moles of the emitting material.

9. The device according to claim 1, wherein the stabilizing material has a reduction potential that is equal to or less negative than that of the emitting material.

10. The device according to claim 1, wherein the stabilizing material provides sites for accepting energy of vibronic energy states of the emitting material.

11. The device according to claim 1, wherein the stabilizing material provides sites for accepting energy of energy states of the emitting material that result from a triplet-triplet annihilation.

12. The device according to claim 1, wherein at least one of excited energy states (S₁, T₁) of the stabilizing material is not higher than a virtual energy state consisting of combined energy of two excited triplet energy states (T₁) of the emitting material.
